(19) United States
(12) Patent Application Publication
(10) Pub. No.: US 2024/0429418 A1
(43) Pub. Date: Dec. 26, 2024

(54) METHOD OF MANUFACTURING AN ION-CONDUCTING MEMBRANE

(71) Applicant: JOHNSON MATTHEY HYDROGEN TECHNOLOGIES LIMITED, London (GB)

(72) Inventors: Jake COOLE, Swindon Wiltshire (GB); Angus DICKINSON, Swindon Wiltshire (GB); Julie O'SULLIVAN, Swindon Wiltshire (GB)

(21) Appl. No.: 18/702,487

(22) PCT Filed: Dec. 8, 2022
(86) PCT No.: PCT/GB2022/053130

§ 371 Date: Apr. 18, 2024

(30) Foreign Application Priority Data
Dec. 8, 2021 (GB) 2117685.4

(51) Int. Cl. H01M 8/1053; H01M 8/102; H01M 8/1039; H01M 8/1058

(52) U.S. Cl. CPC H01M 8/1053; H01M 8/102; H01M 8/1039; H01M 8/1058

(57) ABSTRACT

A method of manufacturing an ion-conducting membrane. comprising the steps of: (a) providing a substrate; (b) depositing a first dispersion onto the substrate to form a first layer, wherein the first dispersion comprises an ion-conducting polymer; (c) depositing a second dispersion onto the first dispersion to form a second layer on the first layer, wherein the second dispersion comprises an ion-conducting polymer; (d) providing a reinforcing component comprising pores so that the second dispersion impregnates at least some of the pores of the reinforcing component; and (e) drying the first and second layers, wherein step (e) is performed after steps (c) and (d).

### FIELD OF THE INVENTION

This invention relates to a method of manufacturing an ion-conducting membrane, such as a proton-exchange membrane. In particular, this invention relates to a method of manufacturing an ion-conducting membrane for an electrochemical device, such as a fuel cell or an electrolyser. This invention also relates to associated methods of manufacturing a catalyst coated ion-conducting membrane, and manufacturing a membrane electrode assembly.

### BACKGROUND OF THE INVENTION

A fuel cell is an electrochemical cell comprising two electrodes separated by an electrolyte. A fuel, such as hydrogen or an alcohol, such as methanol or ethanol, is supplied to the anode and an oxidant, such as oxygen or air, is supplied to the cathode. Electrochemical reactions occur at the electrodes, and the chemical energy of the fuel and the oxidant is converted to electrical energy and heat. Electrocatalysts are used to promote the electrochemical oxidation of the fuel at the anode and the electrochemical reduction of oxygen at the cathode.

In the hydrogen-fuelled or alcohol-fuelled proton exchange membrane fuel cells (PEMFC), the electrolyte is a solid polymeric membrane, which is electronically insulating and proton conducting. Protons, produced at the anode, are transported across the membrane to the cathode, where they combine with oxygen to form water. The most widely used alcohol fuel is methanol, and this variant of the PEMFC is often referred to as a direct methanol fuel cell (DMFC).

The principal component of the PEMFC is known as a membrane electrode assembly (MEA) and is essentially composed of five layers. The central layer is the polymeric ion-conducting membrane. On either side of the ion-conducting membrane there is an electrocatalyst layer, containing an electrocatalyst designed for the specific electrocatalytic reaction. The electrocatalyst layer is electrically conducting. Finally, adjacent to each electrocatalyst layer there is a gas diffusion layer. The gas diffusion layer must allow the reactants to reach the electrocatalyst layer and must conduct the electric current that is generated by the electrochemical reactions. Therefore, the gas diffusion layer must be porous and electrically conducting.

Conventionally, the MEA can be constructed by a number of methods outlined hereinafter.

(i) The electrocatalyst layer may be applied to the gas diffusion layer to form a gas diffusion electrode. Two gas diffusion electrodes can be placed either side of an ion-conducting membrane and laminated together to form the five-layer MEA.

(ii) The electrocatalyst layer may be applied to both faces of the ion-conducting membrane to form a catalyst-coated ion-conducting membrane. Subsequently, gas diffusion layers are applied to both faces of the catalyst-coated ion-conducting membrane.

(iii) An MEA can be formed from an ion-conducting membrane coated on one side with an electrocatalyst layer, a gas diffusion layer adjacent to that electrocatalyst layer, and a gas diffusion electrode on the other side of the ion-conducting membrane.

Known construction methods typically require heating the ion-conducting membrane above its glass transition temperature (T_{g}), which can damage the ion-conducting membrane and lead to defective products.

The polymeric ion-conducting membrane can comprise a reinforcement material, such as a planar porous material, embedded within the thickness of the membrane, to provide for improved mechanical strength of the membrane and thus increased durability of the MEA and lifetime of the fuel cell. MEAs which include a reinforcement material can be susceptible to membrane curl. It is desirable to avoid membrane curl.

Such polymeric ion-conducting membranes also have applications in other electrochemical devices, such as electrolysers. Electrolysis of water, to produce high purity hydrogen and oxygen, can be carried out in both alkaline and acidic electrolyte systems using an electrolyser. Acidic electrolyte systems typically employ a solid proton-conducting polymer electrolyte membrane and are known as polymer electrolyte membrane water electrolysers (PEMWEs). A catalyst-coated ion-conducting membrane is employed within the cell of a PEMWE, which comprises the (proton-conducting) polymer electrolyte membrane with two catalyst layers (for the anode and cathode reactions respectively) applied on either face of the polymer electrolyte membrane. To complete the electrolysis cell, current collectors, which are typically metal meshes, are positioned either side of the catalyst-coated ion-conducting membrane. Such polymeric ion-conducting membranes used in electrolysers can be manufactured using the same or similar processes as those used in the manufacture of polymeric ion-conducting membranes for fuel cells and are susceptible to the same problems.

### SUMMARY OF THE INVENTION

To facilitate commercialisation of electrochemical devices, such as fuel cells and electrolysers, it is desirable to improve the speed of manufacture of the ion-conducting membrane. This will increase the manufacturing rate of the MEA and improve manufacturing capacity and device throughput.

When manufacturing reinforced ion-conducting membranes, it is desirable for the reinforcement material to be centrally embedded within the thickness of the membrane. Typically, the manufacture of reinforced ion-conducting membranes comprises at least three deposition and drying cycles, so that the reinforcement material can be positioned centrally in the thickness of the membrane. It is desirable to improve the efficiency of this process.

The present invention seeks to address at least some of the above described problems, desires and needs. For example, the present invention provides a method of manufacturing an ion-conducting membrane, such as a proton conducting membrane, in a more efficient way, and hence with increased manufacturing throughput.

According to a first aspect of the invention, there is provided a method of manufacturing an ion-conducting membrane, wherein the method comprises the steps of:
(a) providing a substrate;
(b) depositing a first dispersion onto the substrate to form a first layer, wherein the first dispersion comprises an ion-conducting polymer;
(c) depositing a second dispersion onto the first dispersion to form a second layer on the first layer, wherein the second dispersion comprises an ion-conducting polymer;
(d) providing a reinforcing component comprising pores so that the second dispersion impregnates at least some of the pores of the reinforcing component, and
(e) drying the first and second layers,
wherein step (e) is performed after steps (c) and (d).

Depositing the second dispersion as a second layer onto the first dispersion before the first dispersion dries reduces (i.e. to form a second wet layer on the first wet layer) the number of discrete heating and drying steps required during the manufacturing process, and allows the ion-conducting membrane to be manufactured more efficiently.

The first and second dispersions are different. The first and second dispersions typically have a different physical property, such as density, to help reduce the rate of mixing between the first and second layers. Preferably, the density of the first dispersion is greater than the density of the second dispersion.

According to a second aspect of the invention there is provided a method of manufacturing a catalyst-coated ion-conducting membrane comprising the steps of:
providing an ion-conducting membrane manufactured using the method according to the first aspect; and
applying a catalyst layer to the ion-conducting membrane.

According to a third aspect of the invention there is provided a method of manufacturing a membrane-seal assembly comprising the steps of:
providing an ion-conducting membrane manufactured using the method according to the first aspect, or providing a catalyst-coated ion-conducting membrane manufactured using the method according to the second aspect; and
applying a seal component to the ion-conducting membrane or the catalyst-coated ion-conducting membrane.

According to a fourth aspect of the invention there is provided a method of manufacturing a membrane-electrode assembly comprising the steps of:
providing an ion-conducting membrane manufactured using the method according to the first aspect; and
applying a gas diffusion electrode to the ion-conducting membrane.

According to a fifth aspect of the invention there is provided a method of manufacturing a membrane-electrode assembly comprising the steps of:
providing a catalyst-coated ion-conducting membrane according to the second aspect; and
applying a gas diffusion layer to the catalyst-coated ion-conducting membrane.

According to a sixth aspect there is provided a method of manufacturing a membrane-electrode assembly comprising the steps of:
providing a membrane-seal assembly according to the third aspect; and
applying a gas diffusion electrode to the membrane-seal assembly.

According to a seventh aspect of the invention there is provided an ion-conducting membrane for an electrochemical device obtainable using the method according to the first aspect.

Whilst the invention has been described above, it extends to any combination of the features set out above, or in the following description, drawings or claims. For example, any features disclosed in relation to one aspect of the invention may be combined with any feature of another aspect of the invention.

### BRIEF DESCRIPTION OF THE DRAWINGS

Embodiments of the invention will now be described, by way of example only, with reference to the accompanying drawings, in which:

FIGS. 1 and 2 illustrate exemplary methods according to embodiments of the present invention;

FIG. 3 is a representation of a deposition process in which the first and second layers are deposited concurrently;

FIG. 4 shows a second layer on top of a first layer, wherein the density of the second layer is less than the density of the first layer;

FIG. 5 shows a second layer on top of a first layer, wherein the second layer has a lower ionomer concentration than the first layer;

FIG. 6 shows a second layer on top of a first layer, wherein the density of the second layer is less than the density of the first layer; and

FIG. 7 is a scanning electron micrograph (SEM) of a cross-section of an ion-conducting membrane.

### DETAILED DESCRIPTION OF THE INVENTION

The invention provides a method of manufacturing an ion-conducting membrane, such as a proton-exchange membrane. The ion-conducting membrane can be suitable for an electrochemical device, such as a fuel cell or an electrolyser. The method comprises the steps of:
(a) providing a substrate;
(b) depositing a first dispersion onto the substrate to form a first layer, wherein the first dispersion comprises an ion-conducting polymer;
(c) depositing a second dispersion onto the first dispersion to form a second layer on the first layer, wherein the second dispersion comprises an ion-conducting polymer;
(d) providing a reinforcing component comprising pores so that the second dispersion impregnates at least some of the pores of the reinforcing component, and
(e) drying the first and second layers,
wherein step (e) is performed after steps (c) and (d).

It will be clear to the skilled person that many variations of the above basic process are possible, some of which are described in more detail below with reference to the figures. However, all such variations, whether explicitly described or not, are within the scope of the invention.

Depositing the second dispersion as a second wet layer onto the first dispersion before the first dispersion dries reduces the number of discrete heating and drying steps required during the manufacturing process. Consequently, the present method allows an ion-conducting membrane to be manufactured more quickly. Also, using fewer heating and/or drying steps reduces the risk of damaging the ion-conducting membrane during manufacture. This can lead to a more reliable manufacturing process with fewer defective products.

The term “dispersion” as used here means a system in which a dispersed phase (e.g. solid particles) is dispersed in a (liquid) continuous phase. The dispersed phase comprises the ion-conducting polymer. The continuous phase comprises one or more solvents.

The first and second dispersions typically have a different physical property, such as density. This can help the second dispersion form a discrete layer on top of the first dispersion and can help to reduce mixing between the first and second layers prior to drying.

For example, one method is to control the relative densities of the first and second dispersions. Preferably, the density of the first dispersion is greater than the density of the second dispersion. The density of the second dispersion can be at least 0.5%, preferably at least 1%, and more preferably at least 5%, less than the density of the first dispersion, when measured at 20° C. A lower density second dispersion can be deposited onto the first dispersion so that the second dispersion floats on top of the first dispersion. As such, the second dispersion forms a discrete second layer on the first layer. The first and second layers remain as discrete layers at least prior to the drying step. The layered structure of the first and second layers is retained on a timescale that is at least long enough for the drying step to be performed. The drying step is typically commenced less than 10 minutes, preferably less than 3 minutes, more preferably less than about 1 minute, and most preferably less than about 30 seconds, after the second dispersion has been deposited. The first and second layers can be dried simultaneously. The layers can be dried at a temperature in the range of and including 50° C. to 100° C., and preferably 60° C. to 80° C.

Another method is to control the viscosity of the first and second dispersions. For example, if the viscosity of the first and/or second dispersions is sufficiently high when the dispersions are deposited to form the first and second layers respectively, the rate of mixing between the first and second dispersions can be sufficiently slow so that the first and second layers remain as discrete layers at least prior to the drying step. That is, the layered structure of the first and second layers is retained on a timescale that is at least long enough for the drying step to be performed.

A further method is to control the relative concentrations of the ion-conducting polymer in the first and second dispersions. Preferably, the concentration of the ion-conducting polymer in the second dispersion is less than the concentration of the ion-conducting polymer in the first dispersion. In this way, a second dispersion can be deposited onto the first dispersion to form two discrete layers. The first and second layers can remain as discrete layers on a timescale that is at least long enough for the drying step to be performed.

Although the first and second dispersions form discrete layers, some mixing may occur at the interface between the first and second dispersions. Such mixing can form a blended layer at the interface. The blended layer comprises a mixture of the first and second dispersions. Preferably, the mixing between the first and second dispersions is minimal. The first and second dispersions remain as substantially discrete wet layers. Preferably, the first and second layers remain as substantially discrete layers when dried.

The first layer and the second layer form a layered structure. The layered structure can be metastable. For example, the layered structure can be disrupted if a suitably high shear force is applied.

### Reinforcing Component

The method comprises the step of providing a reinforcing component before the step of drying the first and second layers (i.e. before step (e)). Preferably, the reinforcing component is provided into the second layer. Preferably, the reinforcing component is a planar reinforcing component. The reinforcing component comprises pores. The second dispersion impregnates at least some of the pores of the reinforcing component. The reinforcing component becomes a part of the second layer. Preferably, the second dispersion impregnates a majority of (and more preferably all) the pores of the reinforcing component. For example, the second dispersion can impregnate at least 50%, preferably at least 75%, and more preferably at least 90% of the pores of the reinforcing component (as a proportion of the total number of pores in the reinforcing component). The second dispersion can impregnate at least 50%, preferably at least 75%, and more preferably at least 90% of the pore volume of the reinforcing component.

Preferably, the reinforcing component is provided into the second dispersion after the second dispersion is deposited onto the first layer. That is, preferably step (d) is performed after step (c). Alternatively, the reinforcing component can be provided into the second dispersion so that the second dispersion impregnates at least some of the pores of the reinforcing component before the step of depositing the second dispersion onto the first dispersion. That is, step (d) can be performed before step (c). In this case, the reinforcing component and the second dispersion can be deposited onto the first dispersion together, such that the second layer comprises the second dispersion and the reinforcing component.

The reinforcing component can confer mechanical strength to the ion-conducting membrane. The reinforcing component can contain a porous reinforcing material, such as an expanded polytetrafluoroethylene (ePTFE) material or a nanofibre network, such as a network comprising polybenzimidazole (PBI) fibres or glass fibres. The reinforcing component can comprise a plurality of apertures, for example, as described in WO2016/083785A1.

The reinforcing component can have a thickness that is substantially the same as a thickness of the second layer. This can help to control the position of the reinforcing component in the z direction (i.e. in the through-plane direction).

The second dispersion can have a higher degree of wetting towards the reinforcing component than the first dispersion. In this way, the first dispersion can be substantially prevented from impregnating the pores of the reinforcing component. The “degree of wetting” (also referred to as “wettability”) is a measure of how well a liquid wets (i.e. spreads across) a surface. The degree of wetting can be determined by measuring the contact angle of a liquid on a surface. Contact angles can be measured using known techniques, such as using a contact angle meter at room temperature. For example, contact angles can be measured using a PCA-11 contact angle meter, which is commercially available from Kyowa Interface Science Co., Ltd. of Saitama, Japan. A higher contact angle (up to) 180° corresponds to a lower degree of wetting. A lower contact angle corresponds to a higher degree of wetting. The second dispersion can have a lower contact angle on the reinforcing component than the first dispersion, when measured at a temperature of 25° C. using a contact angle meter.

The second dispersion can be substantially fully wetting towards the reinforcing component. For example, the second dispersion can have a contact angle of <90° towards the reinforcing component, when measured using a contact angle meter at a temperature of 25° C. The surface tension of the second dispersion can be sufficiently low to fully wet the reinforcing component. For example, the second dispersion can have a surface tension of less than about 38 mN/m, preferably less than about 28 mN/m, and more preferably less than about 24 mN/m, when measured at a temperature of 25° C. Surface tension can be measured using a tensiometer employing the Wilhelmy plate principle, as described in Vázquez, G et al., J. Chem, Eng. Data, 1995, 40, 611-614

The first dispersion can be substantially non-wetting towards the reinforcing component. For example, the first dispersion can have a contact angle of >90° towards the reinforcing component, when measured using a contact angle meter at a temperature of 25° C. The surface tension of the first dispersion can be sufficiently high so that the first dispersion is substantially non-wetting towards the reinforcing component. For example, the first dispersion can have a surface tension of more than about 30 mN/m, preferably more than about 38 mN/m, and more preferably more than about 42 mN/m, when measured at a temperature of 25° C. Surface tension can be measured using a tensiometer employing the Wilhelmy plate principle, as described in Vázquez, G et al., J. Chem, Eng. Data, 1995, 40, 611-614. Preferably, the first dispersion does not impregnate the pores of the reinforcing component. For example, using a first dispersion comprising a suitably low alcohol content and/or suitably high water content (in wt. % based on the total weight of the continuous phase of the dispersion) can substantially prevent the first dispersion impregnating the pores of the reinforcing component. As a result, the reinforcing component can be disposed directly on top of the first layer without penetrating into the first layer. Consequently, the position of the reinforcing component in the z direction (i.e. through plane direction) can be reliably controlled. In this way, membrane curl can be reduced or eliminated, whilst also improving the efficiency of the manufacturing process. Additionally, providing an ion-conducting first layer which is discrete from the reinforcing component can improve the ion-conductivity across the ion-conducting membrane.

### First Dispersion

The first dispersion is a first ion-conducting membrane layer dispersion. The first dispersion comprises a continuous phase comprising one or more solvents. The first dispersion can comprise a continuous phase comprising (or consisting of) water, a polar solvent (other than water), or (preferably) a mixture thereof. The polar solvent can be a polar protic solvent. Preferably, the polar solvent is an alcohol, more preferably a C₁₋₄ alcohol. The C₁₋₄ alcohol can be methanol, ethanol, propan-1-ol, propan-2-ol, n-butanol, iso-butanol, butan-2-ol, and tert-butyl alcohol, or a mixture thereof. Preferably, the C₁₋₄ alcohol is ethanol and/or propan-1-ol. Most preferably, the C₁₋₄ alcohol is ethanol. Preferably, the continuous phase comprises (or consists essentially of) water and the C₁₋₄ alcohol. More preferably, the continuous phase comprises (or consists essentially of) water and at least one of ethanol or propan-1-ol. Most preferably, the continuous phase comprises (or consists essentially of) water and ethanol.

The continuous phase of the first dispersion can comprise the polar solvent other than water (e.g. C₁₋₄ alcohol) in an amount in the range of <70 wt. %, preferably 10-50 wt. %, or more preferably 20-40 wt. % based on the total weight of the continuous phase. The continuous phase can comprise the polar solvent other than water in any combination of the limits of these ranges. Unless explicitly stated otherwise, the upper and lower limits of all numerical ranges disclosed in this application are included within the range.

The continuous phase of the first dispersion can comprise water in an amount in the range of >30 wt. %, preferably 50-90 wt. %, and more preferably 60-80 wt. %. The continuous phase can comprise water in any combination of the limits of these ranges.

The first dispersion comprises an ion-conducting polymer, which is dispersed in the continuous phase. The ion-conducting polymer can be a proton-conducting polymer or an anion-conducting polymer, such as a hydroxyl anion-conducting polymer. Examples of suitable proton-conducting polymers include perfluorosulphonic acid ionomers (e.g. Nafion® (E.I. DuPont de Nemours and Co.), Aciplex® (Asahi Kasei), Aquivion™ (Solvay Speciality Polymers), Flemion® (Asahi Glass Co.), or ionomers based on a sulphonated hydrocarbon such as those available from FuMA-Tech GmbH as the fumapem® P, E or K series of products, JSR Corporation, Toyobo Corporation, and others. Examples of suitable anion-conducting polymers include A901 made by Tokuyama Corporation and Fumasep FAA from FuMA-Tech GmbH.

The first dispersion can comprise the ion-conducting polymer in an amount in the range of 5-80 wt. %, preferably 10-50 wt. %, more preferably 15-30 wt. %, and most preferably 15-20 wt. % based on the total weight of the first dispersion. The first dispersion can comprise the ion-conducting polymer in any combination of the limits of these ranges. For example, the first dispersion can comprise the ion-conducting polymer in an amount in the range 10-20 wt. %.

Prior to step (e), the first layer is a first wet layer. The step of drying the first layer forms a first ion-conducting membrane layer, which is typically electrically non-conducting. Suitably, the first layer (and hence the first ion-conducting membrane layer) is unreinforced (i.e. does not comprise a reinforcing component).

### Second Dispersion

The second dispersion is a second ion-conducting membrane layer dispersion. The second dispersion can comprise a continuous phase comprising (or consisting of) water, a polar solvent (other than water), or (preferably) a mixture thereof. The polar solvent can be a polar protic solvent. Preferably, the polar solvent is an alcohol, more preferably a C₁₋₄ alcohol. The C₁₋₄ alcohol can be methanol, ethanol, propan-1-ol, propan-2-ol, n-butanol, iso-butanol, butan-2-ol, and tert-butyl alcohol, or a mixture thereof. Preferably, the C₁₋₄ alcohol is ethanol and/or propan-1-ol. Preferably, the continuous phase comprises (or consists essentially of) water and a C₁₋₄ alcohol. More preferably, the continuous phase comprises (or consists essentially of) water and at least one of ethanol or propan-1-ol. Most preferably, the continuous phase comprises (or consists essentially of) water and ethanol.

The continuous phase of the second dispersion can comprise a polar solvent other than water (e.g. C₁₋₄ alcohol) in a higher percent by weight than the continuous phase of the first dispersion, based on the total weight of the respective continuous phase.

The continuous phase of the second dispersion can comprise water in a lower percent by weight than the continuous phase of the first dispersion, based on the total weight of the respective continuous phase.

The continuous phase of the second dispersion can comprise the polar solvent other than water (e.g. C₁₋₄ alcohol) in an amount in the range of 50-100 wt. %, preferably 60-90 wt. %, or most preferably 70-80 wt. % based on the total weight of the continuous phase.

The continuous phase of the second dispersion can comprise water in an amount in the range of 0-50 wt. %, preferably 10-40 wt. %, and most preferably 20-30 wt. % based on the total weight of the continuous phase. The continuous phase can comprise water and the polar solvent other than water in any combination of these ranges.

The second dispersion comprises an ion-conducting polymer, which is dispersed in the continuous phase. The ion-conducting polymer can be a proton-conducting polymer or an anion-conducting polymer, such as a hydroxyl anion-conducting polymer. Examples of suitable proton-conducting polymers include perfluorosulphonic acid ionomers (e.g. Nafion® (E.I. DuPont de Nemours and Co.), Aciplex® (Asahi Kasei), Aquivion™ (Solvay Speciality Polymers), Flemion® (Asahi Glass Co.), or ionomers based on a sulphonated hydrocarbon such as those available from FuMA-Tech GmbH as the fumapem® P, E or K series of products, JSR Corporation, Toyobo Corporation, and others. Examples of suitable anion-conducting polymers include A901 made by Tokuyama Corporation and Fumasep FAA from FuMA-Tech GmbH. The ion-conducting polymer of the first and second dispersions can be the same or different.

The second dispersion can comprise the ion-conducting polymer in an amount in the range of 5-80 wt. %, preferably 10-50 wt. %, preferably 15-30 wt. %, and most preferably 15-20wt. % based on the total weight of the second dispersion. The second dispersion can comprise the ion-conducting polymer in any combination of the limits of these ranges. For example, the second dispersion can comprise the ion-conducting polymer in an amount in the range 10-20 wt. %. The first and second dispersions can comprise an ion-conducting polymer in substantially the same or different percent by weight based on the total weight of the respective dispersion. The first dispersion can comprise the ion-conducting polymer in a different (i.e. higher or lower) percent by weight than the second dispersion, based on the total weight of the respective dispersions.

Prior to step (e), the second layer is a second wet layer. The step of drying the second layer forms a second ion-conducting membrane layer, which is typically electrically non-conducting.

### Steps (b) and (c)

The first dispersion and the second dispersion can be deposited concurrently. That is, the first dispersion can be deposited onto the substrate at the same time as the second dispersion is deposited onto the first dispersion. Depositing the first and second dispersions concurrently can significantly increase manufacturing efficiency, manufacture speed, and hence can significantly increase manufacture capacity and throughput.

The first and second dispersions can independently be deposited using a slot-die (slot, extrusion) coating process (whereby the dispersion is squeezed out by gravity or under pressure via a slot onto the substrate), knife-coating, bar coating, inkjet printing, gravure printing, curtain coating, or a spray coating process. These exemplar techniques can substantially avoid mixing between the first and second dispersions. The first and second dispersions can be deposited using the same or a different technique. Preferably, the first and second dispersions are deposited using a slot-die coating process. More preferably, the first and second dispersions are deposited using a dual slot-die coating process. The slot-die coating process can comprise providing a slot die head comprising a first outlet and a second outlet. The first dispersion can be deposited onto the substrate via the first outlet. The second dispersion can be deposited onto the first dispersion via the second outlet. Slot die coating (or dual slot die coating) can provide a suitable method for depositing the second dispersion onto the first dispersion whilst minimising turbulence, and hence minimising mixing, between the first and second layers.

### Step (e)

Step (e) is performed after both steps (c) and (d). Step (e) comprises drying both the first and second layers. Step (e) suitably comprises removing substantially all solvent from the first and second layers.

### Third Dispersion

The method can further comprise the steps of:
(f) depositing a third dispersion onto the second layer to form a third layer, wherein the third dispersion comprises an ion-conducting polymer; and
(g) drying the third layer.
   Typically, the third dispersion is deposited after the step of drying the first and second layers (i.e. after step (e)). Alternatively, the third dispersion can be deposited onto the second dispersion to form a third (wet) layer on the second (wet) layer. The step of drying the third layer forms a third ion-conducting membrane layer, which is typically electrically non-conducting. Suitably, the third layer (and hence the third ion-conducting membrane layer) is unreinforced (i.e. does not comprise a reinforcing component).

The steps of drying the first, second and third layers can form a three-layer ion-conducting membrane. The three-layer ion-conducting membrane comprises the dried first layer, the dried second layer, and the dried third layer, wherein the dried second layer is disposed between the dried first and third layers. The dried second layer comprises the reinforcing component. Preferably, the dried first and third layers are unreinforced. The three-layer ion-conducting membrane can be electrically non-conducting. The three-layer ion-conducting membrane can be suitable for use as an ion-conducting electrolyte of a fuel cell or water electrolysis cell. That is, the ion-conducting membrane can be an electrolyte membrane.

Where the second dispersion only impregnates some but not all of the pores of the reinforcing component, the third dispersion can impregnate any remaining unimpregnated pores of the reinforcing component. The third dispersion can have the same or a different composition to the first or second dispersions.

The third dispersion is a third ion-conducting membrane layer dispersion. The third dispersion can comprise a continuous phase comprising (or consisting of) water, a polar solvent (other than water), or a mixture thereof. The polar solvent can be a polar protic solvent. Preferably, the polar solvent is an alcohol, more preferably a C₁₋₄ alcohol. The C₁₋₄ alcohol can be methanol, ethanol, propan-1-ol, propan-2-ol, n-butanol, iso-butanol, butan-2-ol, and tert-butyl alcohol, or a mixture thereof. Preferably, the C₁₋₄ alcohol is ethanol and/or propan-1-ol. Preferably, the continuous phase comprises (or consists essentially of) water and a C₁₋₄ alcohol. More preferably, the continuous phase comprises (or consists essentially of) water and at least one of ethanol or propan-1-ol. Most preferably, the continuous phase comprises (or consists essentially of) water and ethanol. The continuous phase of the third dispersion can have the same composition as the first or second dispersions.

The continuous phase of the third dispersion can comprise the polar solvent other than water (e.g. C₁₋₄ alcohol) in an amount in the range of >40 wt. %, preferably 50-90 wt. %, or more preferably 70-80 wt. % based on the total weight of the continuous phase.

The continuous phase of the third dispersion can comprise water in an amount in the range of <60 wt. %, preferably 10-50 wt. %, and more preferably 20-30 wt. %.

The third dispersion comprises an ion-conducting polymer, which is dispersed in the continuous phase. The ion-conducting polymer can be a proton-conducting polymer or an anion-conducting polymer, such as a hydroxyl anion-conducting polymer. Examples of suitable proton-conducting polymers include perfluorosulphonic acid ionomers (e.g. Nafion® (E.I. DuPont de Nemours and Co.), Aciplex® (Asahi Kasei), Aquivion™ (Solvay Speciality Polymers), Flemion® (Asahi Glass Co.), or ionomers based on a sulphonated hydrocarbon such as those available from FuMA-Tech GmbH as the fumapem® P, E or K series of products, JSR Corporation, Toyobo Corporation, and others. Examples of suitable anion-conducting polymers include A901 made by Tokuyama Corporation and Fumasep FAA from FuMA-Tech GmbH. The ion-conducting polymer of the third dispersion can be the same as the ion-conducting polymer of the first or second dispersions.

The third dispersion can comprise the ion-conducting polymer in an amount in the range of 5-80 wt. %, preferably 10-50 wt. %, preferably 15-30 wt. %, and most preferably 15-20 wt. % based on the total weight of the second dispersion. The third dispersion can comprise the ion-conducting polymer in any combination of the limits of these ranges. For example, the third dispersion can comprise the ion-conducting polymer in an amount in the range 10-20 wt. %. The third dispersion can comprise substantially the same percent by weight of ion-conducting polymer as the first and/or second dispersions based on the total weight of the respective dispersion.

Preferably, the third layer has substantially the same thickness (in the z direction) as the first layer. The dried third layer can have the same thickness as the dried first layer. Therefore, any reinforcing component can be reliably positioned centrally in the membrane (in the z direction) between the first and third layers, which can reduce membrane curl. Providing first and third layers either side of the reinforcing component can improve the ion-conductivity across the ion-conducting membrane.

### The Substrate

The method can further comprise the step of removing the substrate after the step of drying the first and second layers. Where a third layer is deposited, the substrate can be removed after the step of drying the third layer.

The substrate provides the surface onto which the first dispersion is deposited.

The substrate can be a backing layer. The backing layer provides support for the ion-conducting membrane during manufacture and if not immediately removed, can provide support and strength during any subsequent storage and/or transport. The material from which the backing layer is made should provide the required support, preferably be compatible with the first dispersion, preferably be impermeable to the first dispersion, be able to withstand the process conditions involved in producing the ion-conducting membrane and be able to be easily removed without damage to the ion-conducting membrane. Examples of materials suitable for use include a fluoropolymer, such as polytetrafluoroethylene (PTFE), ethylene tetrafluoroethylene (ETFE), perfluoroalkoxy polymer (PFA), fluorinated ethylene propylene (FEP—a copolymer of hexafluoropropylene and tetrafluoroethylene), and polyolefins, such as biaxially oriented polypropylene (BOPP). Other examples include laminates, multi-layer extrusions and coated films/foils capable of retaining their mechanical strength/integrity at elevated temperatures, for example temperatures up to 200° C. Examples include laminates of: poly (ethylene-co-tetrafluoroethylene) and polyethylene naphthalate (PEN); polymethylpentene (PMP) and PEN; polyperfluoroalkoxy (PFA) and polyethylene terephthalate (PET) and polyimide (PI). The laminates can have two or more layers, for example ETFE-PEN-ETFE, PMP-PEN-PMP, PFA-PET-PFA, PEN-PFA, FEP-PI-FEP, PFA-PI-PFA and PTFE-PI-PTFE. The layers may be bonded using an adhesive, such as acrylic or polyurethane.

The substrate can be a catalyst layer. The catalyst layer can be on a backing layer as defined above, wherein the first dispersion is deposited onto the catalyst layer. The method can further comprise removing the backing layer from the catalyst layer after the step of drying the first and second layers (or after step (g) if present). Where the substrate is a catalyst layer, the backing layer can be a gas diffusion layer. The gas diffusion layer can remain attached to the catalyst layer.

The catalyst layer comprises a catalyst. The catalyst layer can be for an electrode (e.g. anode or cathode) of a fuel cell or electrolyser. The catalyst is suitably an electrocatalyst. The catalyst can be a finely divided unsupported metal powder, or may be a supported catalyst wherein small metal nanoparticles are dispersed on an electrically conducting particulate carbon support. The electrocatalyst metal is suitably selected from:
(i) the platinum group metals (i.e. platinum, palladium, rhodium, ruthenium, iridium, and osmium),
(ii) gold or silver,
(iii) a base metal, or
(iv) an alloy or mixture comprising one or more of these metals or their oxides. The preferred electrocatalyst metal is platinum, which may be alloyed with other precious metals or base metals. If the electrocatalyst is a supported catalyst, the loading of metal particles on the carbon support material is suitably in the range 10-90 wt %, preferably 15-75 wt % of the weight of resulting electrocatalyst.

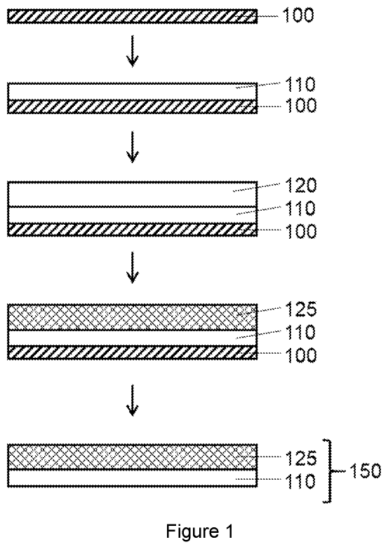

FIGS. 1 to 3 depict exemplary methods of the present invention. The dimensions (e.g. thickness) of each layer are not drawn to scale for the sake of clarity. The same reference signs have been used throughout the figures to refer to features and method steps which are identical.

With reference to FIG. 1, a first dispersion is deposited onto a substrate 100 to form a first layer 110. The first dispersion comprises an ion-conducting polymer. A second dispersion is deposited onto the first dispersion whilst the first dispersion is still wet to form a second layer 120 on the first layer 110. The second dispersion comprises an ion-conducting polymer. The second dispersion typically has a lower density than the first dispersion so that the second dispersion floats on top of the first dispersion. The first and second layers 110, 120 form a layered structure. A porous reinforcing component, such as an ePTFE material or a network of PBI fibres, is laid onto the second layer 120, whilst the second dispersion is still wet, to provide a reinforced second layer 125. The second dispersion impregnates the pores of the reinforcing component. Preferably, the first dispersion exhibits a lower degree of wetting towards the reinforcing component compared to the second dispersion so that the first dispersion does not impregnate the pores of the reinforcing component. The reinforcing component resides within the second layer. The reinforcing component resides on top of the first layer 110. The first and second layers are subsequently dried to form a reinforced ion-conducting membrane 150, comprising an unreinforced first layer 110 and a reinforced second layer 125. The substrate 100 can subsequently be removed, if desired.

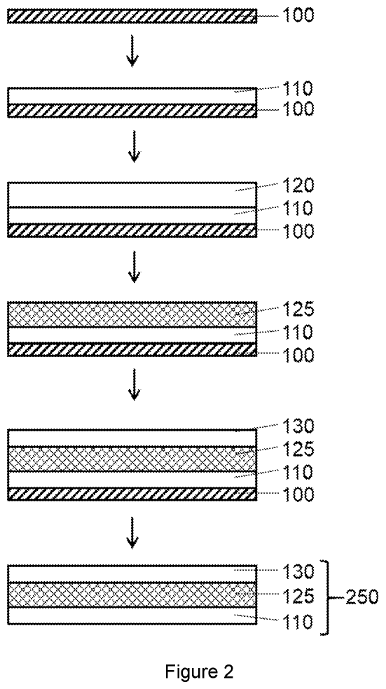

FIG. 2 shows a further embodiment of the invention. The first dispersion, second dispersion and reinforcing component are deposited and dried in the same manner as described in relation to FIG. 1. The embodiment of FIG. 2 includes the additional subsequent step of depositing a third dispersion onto the second layer 125 to form a third layer 130. The third dispersion comprises an ion-conducting polymer. The third layer 130 is subsequently dried. The resulting product is a reinforced ion-conducting membrane 250 comprising a reinforced second ion-conducting layer 125 disposed centrally between unreinforced first and third ion-conducting layers 110, 130. The substrate 100 can be subsequently removed, if desired. The reinforced ion-conducting membrane 250 can be used in a fuel cell or an electrolyser.

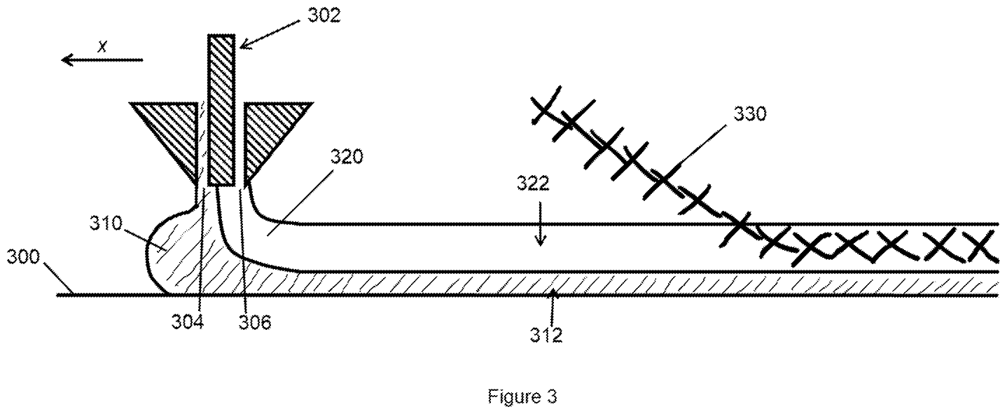

In either of the methods of FIG. 1 or 2, the first and second dispersions can be deposited concurrently. That is, the second dispersion can be deposited onto the first dispersion whilst the first dispersion is still being deposited. Preferably, the first and second dispersions contact or form an interface with each other prior to forming the first and second layers respectively. FIG. 3 illustrates an exemplary method in which first and second dispersions are deposited concurrently. FIG. 3 illustrates a preferred dual head slot die coating process, although alternative coating techniques may be also used.

A substrate 300 is positioned under a slot die head 302. The slot die head 302 is a dual slot die head comprising a first outlet 304 and a second outlet 306. A first ionomer dispersion 310 is deposited onto the substrate 300 via the first outlet 304. The first ionomer dispersion 310 forms a first layer 312. By way of example, the first ionomer dispersion 310 can have a continuous phase comprising 40 wt. % ethanol and 60 wt. % water (based on the total weight of the continuous phase).

A second ionomer dispersion 320 is deposited onto the first ionomer dispersion 310, whilst the first ionomer dispersion 310 is still wet, to form a second layer 322. By way of example, the second ionomer dispersion 320 has a continuous phase comprising 80 wt. % ethanol and 20 wt. % water (based on the total weight of the continuous phase). The first ionomer dispersion 310 has a higher density than the second ionomer dispersion 320. The mixing between the first and second ionomer dispersions is minimal.

As the first and second ionomer dispersions are deposited, the slot die head 302 moves relative to the substrate 300 in the direction marked x. Typically, the slot die head 302 is moved at a substantially constant speed during the deposition process, which can help afford a uniform coating thickness.

FIG. 3 shows the step of providing a porous reinforcing component 330 in the second layer 322. The porous reinforcing component 330 is laid onto the second ionomer dispersion 320 whilst the first and second ionomer dispersions 310, 320 are still wet. The second ionomer dispersion 320 impregnates the pores of the reinforcing component 330. However, the first layer 312 does not impregnate the pores of the reinforcing component 330. Without wishing to be bound by any theory or conjecture, it is believed that the lower wettability of the first layer 312 towards the reinforcing component substantially prevents the reinforcing component from sinking into the first layer 312. The reinforcing component resides within the second layer 322. The reinforcing component 330 resides directly on top of the first wet layer 312. Therefore, the reinforcing component 330 can be reliably placed in the z direction (vertical direction as viewed in FIG. 3), which can help to avoid membrane curling.

### EXAMPLE 1

A first dispersion comprising 10 wt. % ethanol and 90 wt. % water (based on the total weight of the continuous phase), 25 wt. % ionomer (based on the total weight of the first dispersion) was added to a sample vial. A dye was also added to the first dispersion for ease of identification purposes. The dye did not otherwise materially affect the properties of the dispersion.

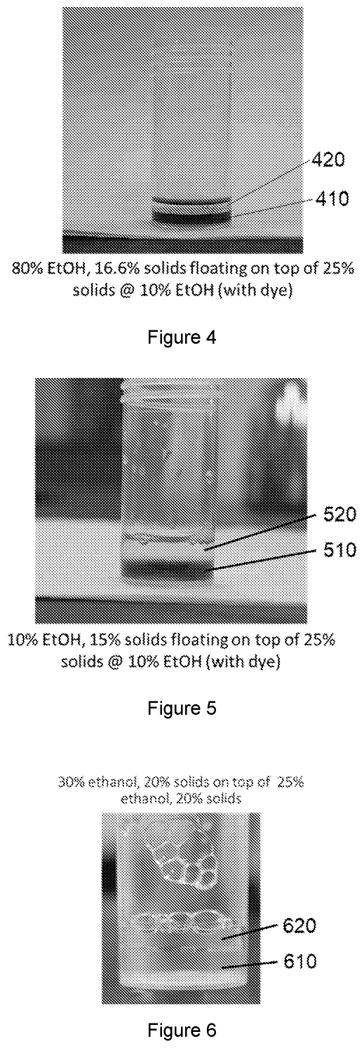

A second dispersion comprising 80 wt. % ethanol and 20 wt. % water (based on the total weight of the continuous phase) and ˜17 wt. % ionomer (based on the total weight of the second dispersion) was added dropwise so that the drops ran down the side wall of the sample vial. The second dispersion had a lower density than the first dispersion. The second dispersion 420 formed a discrete layer on top of the first dispersion 410, as shown in FIG. 4.

The layered structure was metastable. The layered structure could be irreversibly disrupted by applying a shear (mixing) force. However, the layers remained stable for up to 48 hours when left unperturbed.

### EXAMPLE 2

A first dispersion comprising 10 wt. % ethanol and 90 wt. % water (based on the total weight of the continuous phase), 25 wt. % ionomer (based on the total weight of the first dispersion) was added to a sample vial. A dye was also added to the first dispersion for ease of identification purposes. The dye did not otherwise materially affect the properties of the dispersion.

A second dispersion comprising 10 wt. % ethanol and 90 wt. % water (based on the total weight of the continuous phase) and 15 wt. % ionomer (based on the total weight of the second dispersion) was added dropwise so that the drops ran down the side wall of the sample vial. The second dispersion had a lower ionomer concentration than the first dispersion. The second dispersion 520 formed a discrete layer on top of the first dispersion 510, as shown in FIG. 5.

The layered structure was metastable. The layered structure could be irreversibly disrupted by applying a shear (mixing) force. However, the layers remained stable for up to 48 hours if left unperturbed.

### EXAMPLE 3

A first dispersion comprising 25 wt. % ethanol and 75 wt. % water (based on the total weight of the continuous phase), 20 wt. % ionomer (based on the total weight of the first dispersion) was added to a sample vial.

A second dispersion comprising 30 wt. % ethanol and 70 wt. % water (based on the total weight of the continuous phase) and 20 wt. % ionomer (based on the total weight of the second dispersion) was added dropwise so that the drops ran down the side wall of the sample vial. The second dispersion had a lower density than the first dispersion. The second dispersion 620 formed a discrete layer on top of the first dispersion 610, as shown in FIG. 6.

The layered structure was metastable. The layered structure could be irreversibly disrupted by applying a shear (mixing) force. However, the layers remained stable for up to 48 hours if left unperturbed.

### EXAMPLE 4

A first dispersion was coated onto a polyethylene terephthalate (PET) substrate using bar coating to form a first layer. The first dispersion comprised a continuous phase of 60 wt. % water and 40 wt. % ethanol based on the total weight of the continuous phase. The first dispersion further comprised an ionomer in an amount of ˜17 wt % based on the total weight of the first dispersion. The wet layer thickness of the first layer was 30 μm.

A second dispersion was coated onto a separate PET substrate using bar coating to form a second layer. The second dispersion comprises a continuous phase of 20 wt. % water and 80 wt. % ethanol based on the total weight of the continuous phase. The second dispersion further comprised an ionomer in an amount of ˜17 wt % based on the total weight of the second dispersion. The wet layer thickness of the second layer was 200 μm.

A sheet of expanded PTFE (available from Ningbo Quantum Seal Co. Ltd.) was placed into the second layer, whilst the second layer was still wet, until the pores of the expanded PTFE sheet were fully impregnated with the second dispersion. The expanded PTFE sheet was subsequently placed on top of the first layer, whilst the first and second dispersions were still wet. The expanded PTFE sheet was pulled down onto the first layer to ensure a good contact between the expanded PTFE sheet and the first layer.

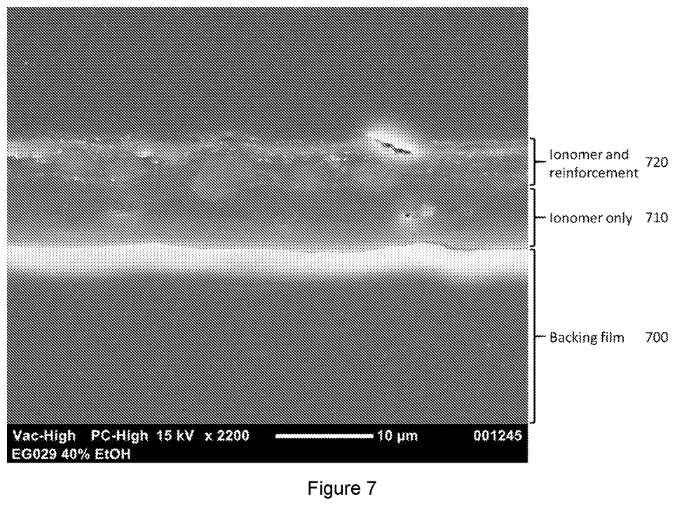

The first layer and the reinforced second layer were dried in a convection oven at 80° C. to form an ion-conducting membrane comprising a first unreinforced layer and a second reinforced layer. FIG. 7 shows an SEM image of a cross-section of the dried ion-conducting membrane on a backing film 700. The first layer 710 consists of an ion-conducting polymer only. The second layer 720 comprises a reinforcing component and an ion-conducting polymer. The first layer 710 is in direct contact with but remains separate from the reinforced second layer 720. In this example, the first dispersion has a lower wettability towards the reinforcing component than the second dispersion. Consequently, the first dispersion does not impregnate the pores of the reinforcing component, and the first layer remains as a discrete layer of known thickness, even when the reinforcing component is added when the first layer is still wet. Therefore, the through-plane positional placement of the reinforcing component can be reliably controlled, whilst reducing the number of drying steps required to manufacture the ion-conducting membrane.

1. A method of manufacturing an ion-conducting membrane, wherein the method comprises the steps of:
(a) providing a substrate;
(b) depositing a first dispersion onto the substrate to form a first layer, wherein the first dispersion comprises an ion-conducting polymer;
(c) depositing a second dispersion onto the first dispersion to form a second layer on the first layer, wherein the second dispersion comprises an ion-conducting polymer;
(d) providing a reinforcing component comprising pores so that the second dispersion impregnates at least some of the pores of the reinforcing component; and
(e) drying the first and second layers,
wherein step (e) is performed after steps (c) and (d).

2. The method according to claim 1, wherein the first dispersion has a density that is greater than the density of the second dispersion.

3. The method according to claim 1, wherein the second dispersion has a surface tension that is less than the surface tension of the first dispersion.

4. The method according to claim 1, wherein the second dispersion has a higher degree of wetting towards the reinforcing component than the first dispersion.

5. The method according to claim 1, wherein the reinforcing component has a thickness that is substantially the same as a thickness of the second layer.

6. The method according to claim 1, wherein the first dispersion comprises a continuous phase comprising water, a polar solvent other than water, or a mixture thereof.

7. The method according to claim 6, wherein the continuous phase of the first dispersion comprises the polar solvent other than water in an amount in the range of <70 wt. %, preferably 10-50 wt. %, or more preferably 20-40 wt. % based on the total weight of the continuous phase.

8. The method according to claim 1, wherein the second dispersion comprises a continuous phase comprising water, a polar solvent other than water, or a mixture thereof.

9. The method according to claim 8, wherein the continuous phase of the second dispersion comprises the polar solvent other than water in an amount in the range of and including 50-100 wt. %, preferably 60-90 wt. %, or more preferably 70-80 wt. % based on the total weight of the continuous phase.

10. The method according to claim 1, in which the first dispersion and the second dispersion are deposited concurrently.

11. The method according to claim 1, in which the first dispersion and/or second dispersion is deposited using a slot-die coating process, knife-coating, bar coating, inkjet printing, gravure printing, curtain coating, or a spray coating process.

12. The method according to claim 11, in which the slot die coating process comprises providing a slot die head comprising a first outlet and a second outlet, wherein the first dispersion is deposited onto the substrate via the first outlet, and the second dispersion is deposited onto the first dispersion via the second outlet.

13. The method according to claim 1, further comprising the steps of:
(f) depositing a third dispersion onto the second layer to form a third layer, wherein the third dispersion comprises an ion-conducting polymer; and
(g) drying the third layer.

14. The method according to claim 13, wherein the step of depositing the third dispersion is performed after the step of drying the first and second layers.

15. The method according to claim 13, in which the third layer has a thickness that is substantially the same as a thickness of the first layer.

16. The method according to claim 1, further comprising the step of removing the substrate after the step of drying the first and second layers.

17. The method according to claim 1, wherein the substrate is a catalyst layer.

18. A method of manufacturing a catalyst-coated ion-conducting membrane comprising the steps of:
providing an ion-conducting membrane manufactured using the method according to claim 1; and
applying a catalyst layer to the ion-conducting membrane.

19-20. (canceled)

21. A method of manufacturing a membrane-electrode assembly comprising the steps of:
providing a catalyst coated ion-conducting membrane manufactured using the method according to claim 18; and
applying a gas diffusion layer to the catalyst coated ion-conducting membrane.

22-23. (canceled)
